(19) United States
(12) Patent Application Publication
(10) Pub. No.: US 2025/0306548 A1
(43) Pub. Date: Oct. 2, 2025

(54) LEARNING APPARATUS, CONTROL APPARATUS, LEARNING METHOD, AND NON-TRANSITORY COMPUTER READABLE MEDIUM

(71) Applicants: NEC Corporation, Tokyo (JP); NATIONAL INSTITUTE OF ADVANCED INDUSTRIAL SCIENCE AND TECHNOLOGY, Tokyo (JP)

(72) Inventors: Shumpei KUBOSAWA, Ibaraki (JP); Junya Ikemoto, Ibaraki (JP); Takashi Onishi, Ibaraki (JP); Yoshimasa Tsuruoka, Ibaraki (JP)

(73) Assignees: NEC Corporation, Tokyo (JP); NATIONAL INSTITUTE OF ADVANCED INDUSTRIAL SCIENCE AND TECHNOLOGY, Tokyo (JP)

(21) Appl. No.: 19/087,691

(22) Filed: Mar. 24, 2025

(30) Foreign Application Priority Data
Mar. 26, 2024 (JP) 2024-050148

(51) Int. Cl. G05B 13/04; G05B 13/02; G06F 17/13

(52) U.S. Cl. CPC G05B 13/048; G05B 13/027; G06F 17/13

(57) ABSTRACT

An object of the present disclosure is to perform learning of a model relatively efficiently. A prediction model apparatus according to the present disclosure includes: prediction model structure determination means for determining a structure of a prediction model by using information about a structure of a system to be modeled; and model learning means for performing learning of the model so that a difference between an output value of the system to be modeled and an output value of the model becomes small.

### INCORPORATION BY REFERENCE

This application is based upon and claims the benefit of priority from Japanese patent application No. 2024-50148, filed on Mar. 26, 2024, the disclosure of which is incorporated herein in its entirety by reference.

### TECHNICAL FIELD

The present disclosure relates to a learning apparatus, a control apparatus, a learning method, and a program.

### BACKGROUND ART

In order to control the state of a plant, a model that simulates operations of the plant is used in some cases. In this case, if the model is differentiable, optimization calculation of the operation using a gradient method, such as Model Predictive Control (MPC) based on a gradient method, can be performed. For example, Non Patent Literature 1 discloses a method in which a dynamic simulator constructed using prior knowledge of the laws of physics, plant design information, and the like is used. Non Patent Literature 1 further discloses that operation data of a plant is collected using the dynamic simulator, and an ordinary differential equation model expressed by a neural network is constructed by supervised learning using the collected pieces of data. Non Patent Literature 1 further discloses that model predictive control based on a gradient method is performed using the constructed model.

In addition to ordinary differential equations that express the operations of a plant quantitatively etc., Multilevel Flow Modeling (MFM) disclosed in Non Patent Literature 2 is known. The MFM disclosed in Non Patent Literature 2 is a method for qualitatively expressing the operations of a plant as a relation in which a state change of one apparatus spreads to another apparatus based on a connection structure between the apparatuses constituting the plant. In the MFM, the function and the purpose of each of the apparatuses and a flow of materials and a flow of energy between the apparatuses are expressed, and a relation in which a state change of one apparatus spreads to another apparatus in accordance with a structure of the flow between the apparatuses is described.
[Non Patent Literature 1] Kubosawa et al., Nonlinear Model Predictive Control using Neural ODE Replicas of Dynamic Simulators, 4th Asia Pacific Conference of the Prognostics and Health Management, Tokyo, Japan, Sep. 11-14, 2023
[Non Patent Literature 2] M. Lind, An introduction to multilevel flow modeling, International Electronic Journal of Nuclear Safety and Simulation, 2 (1), (2011)

### SUMMARY

A model constructed by supervised learning using data obtained from a system to be modeled has a problem that the reproducibility of the state that is away from a state experienced at the time of learning is low.

An example of an object of the present disclosure is to provide a learning apparatus, a control apparatus, a learning method, and a program which can solve the above-described problem.

According to a first example aspect of the present disclosure, a learning apparatus includes: means for determining a structure of a prediction model from information about a function and a structure of a control target system; learning data input value determination means for determining an input value to be used to perform learning of the prediction model; and model learning means for updating a parameter of the prediction model so that a difference between an output value of the control target system and an output value of the prediction model that are output in response to an input of the input value becomes small.

According to a second example aspect of the present disclosure, a control apparatus includes control means for controlling a control target apparatus by using a prediction model determined based on information about a function and a structure of a control target system.

According to a third example aspect of the present disclosure, a learning method performed by a computer includes: determining a structure of a prediction model from information about a function and a structure of a control target system; determining an input value to be used to perform learning of the prediction model; and updating a parameter of the prediction model so that a difference between an output value of the control target system and an output value of the prediction model that are output in response to an input of the input value becomes small.

According to a fourth example aspect of the present disclosure, a program causes a computer to: determine a structure of a prediction model from information about a function and a structure of a control target system; determine an input value to be used to perform learning of the prediction model; and update a parameter of the prediction model so that a difference between an output value of the control target system and an output value of the prediction model that are output in response to an input of the input value becomes small.

According to one example aspect of the present disclosure, the reproducibility of a state that is not experienced at the time of learning can be improved.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram showing an example of a configuration of a learning system according to the present disclosure;

FIG. 2 is a diagram showing an example of input/output data between components in the learning system according to the present disclosure;

FIG. 3 is a diagram showing an example of a processing procedure for performing learning of a prediction model in the learning system according to the present disclosure;

FIG. 4 is a diagram showing an example of a processing procedure for constructing a neural network that constitutes a prediction model in the learning system according to the present disclosure;

FIG. 5 is a Piping and Instrumentation Diagram (P&ID) showing an example of a chemical process according to the present disclosure;

FIG. 6 is a diagram showing an example of a chemical process according to the present disclosure by a flow model;

FIG. 7 is a diagram showing a flow model of an example of a chemical process according to the present disclosure by an adjacency matrix;

FIG. 8 is a diagram showing an example of a chemical process according to the present disclosure by a P&ID;

FIG. 9 is a diagram showing an example of a chemical process according to the present disclosure by a flow model;

FIG. 10 is a diagram showing an example of a configuration of a control system according to the present disclosure; and

FIG. 11 is a diagram showing an example of a configuration of a computer according to the present disclosure.

### EXAMPLE EMBODIMENT

Although example embodiments of the present disclosure will be described below, the following descriptions thereof do not limit the disclosure according to claims. Further, all of the features or all of the combinations of the features shown in the following example embodiments are not necessarily essential as means enabling the invention to solve the problem. In the following description, a character to which a circumflex is attached may be expressed by a “\hat{ }” placed after the character. For example, x to which a circumflex is attached may also be expressed as x\hat{ }.

### First Example Embodiment

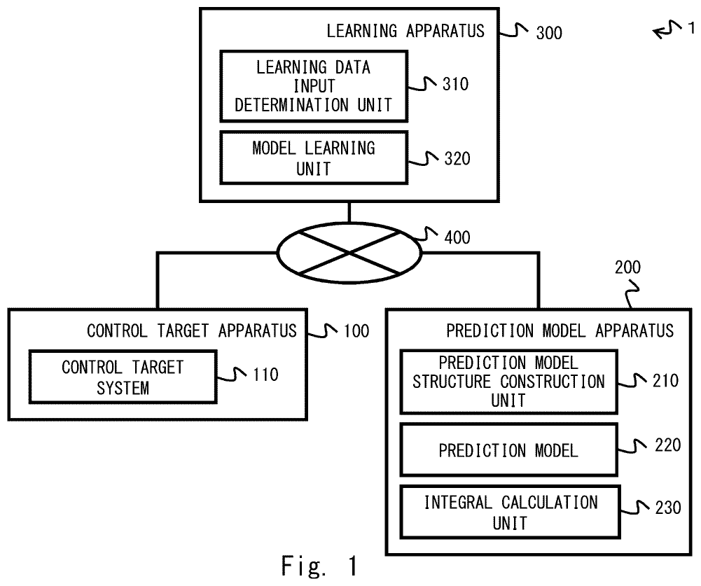

FIG. 1 is a diagram showing an example of a configuration of a learning system. In the configuration shown in FIG. 1, a learning system 1 includes a control target apparatus (i.e., an apparatus to be controlled) 100, a prediction model apparatus 200, a learning apparatus 300, and a communication network 400. The control target apparatus includes a control target system (i.e., a system to be controlled) 110. The prediction model apparatus 200 includes a prediction model structure construction unit 210, a prediction model 220, and an integral calculation unit 230. The learning apparatus 300 includes a learning data input determination unit 310 and a model learning unit 320.

The learning system 1 performs learning of the prediction model 220. In learning of the prediction model, parameter values of the model are adjusted by using training data. Learning of the model is also referred to as training of the model.

The control target apparatus 100 inputs operation information and the like to the control target system 110, and obtains, as an output, the state of the control target system 110 affected by the input and the lapse of time. The control target system 110 may be composed of mechanically operated apparatuses or a computer that reproduces their behaviors by simulation calculation.

In a case where the control target system 110 is a mechanically operated apparatus, the control target system 110 includes means for converting the input from data into an input such as a mechanical operation and means for converting the state into data. Further, the control target system 110 includes means for communicating with other apparatuses through a communication network.

The control target system 110 is not limited to an apparatus for a specific application, and instead may be, for example, an apparatus such as a transportation machine or a machine tool, a facility such as a factory or a power plant including a plurality of apparatuses, or a computer simulation of the aforementioned apparatus or facility.

Input values input to the control target system 110 and output values of the control target system 110 may be a combination of a plurality of values such as tensors including vectors and matrices.

The prediction model apparatus 200 constructs a structure of the prediction model by the prediction model structure construction unit 210 at least once immediately after learning is started. The integral calculation unit 230 executes calculation using the prediction model 220 reflecting the structure. The prediction model apparatus 200 may be composed of a computer. The prediction model 220 reproduces the operations of the control target system 110.

The prediction model 220 receives an input similar to that received by the control target system 110, such as operation information. The prediction model 220 calculates a state of the control target system 110 in a case where the control target system 110 operates in response to the input of operation information, and outputs it. The input of the prediction model 220 may be a combination of a plurality of values such as tensors including vectors and matrices.

The prediction model 220 may comprise a differentiable model such as a Neural Ordinary Differential Equation (Neural ODE). The differentiable model described herein is a model that can calculate the time derivative of the output value of the model and the partial derivative of the output value of the model in accordance with the input value input to the model. For example, in a case where the prediction model 220 comprises a neural ordinary differential equation, a neural ordinary differential equation f is expressed as the equation (1).

$$[ Expression 1 ]$$

$$\frac{d \hat{x}}{dt} = f ( {\hat{x}}_{‵} u ; Θ ) \qquad ( 1 )$$

In the equation (1), x\hat{ } indicates an internal state of the prediction model 220. The internal state x\hat{ } of the prediction model 220 can be regarded as a predicted value of the state of the control target system 110 by the prediction model 220. Note that dx\hat{ }/dt indicates the time derivative of the internal state x\hat{ } of the prediction model 220. In the equation (1), u indicates an input value input to the prediction model 220, and
Θ indicates a parameter of the neural ordinary differential equation constituting the prediction model 220.

The equation (1) indicates that the neural ordinary differential equation f outputs the time derivative of the internal state of the prediction model 220, that is, the time derivative indicating a temporal change of the state of the control target system 110, in accordance with the internal state x\hat{ } of the prediction model 220 and the input of the prediction model 220.

In a case where a structure of the neural network constituting the neural ordinary differential equation in the equation (1) is designed, if knowledge about the function and the structure of the control target system 110 can be used, constraints can be given to the computational structure of the neural network.

A description will be given of a case in which the amount of training data for learning of the prediction model 220 obtained from the control target system 110 is relatively small or a large amount of data of similar states is included in training data. A case in which the amount of training data is relatively small may mean a case in which the number of variations of state data included in training is reduced. Further, a case in which the amount of training data is relatively small may mean the same case as that in which a small amount of training data is used as a result of a small number of variations of state data. Further, a case in which training data includes a large number of data of a similar state may mean a case in which training data includes a wide variety of state data. A case in which training data includes a large amount of data of similar states may mean the same case as that in which a large amount of training data is used as a result of the increase of the amount of training data and the inclusion of a wide variety of state data. Whether the number of variations is large or small may be determined based on, for example, whether the number of variations is larger or smaller than at least one threshold. Further, whether the amount of training data is large or small may be determined based on whether the number of variations is larger or smaller than at least one threshold. In this case, a situation that can be predicted and reproduced by the prediction model 220 trained by the above data is limited, and high performance of each of interpolation and extrapolation cannot be expected. Further, in the case of a small amount of training data, a small amount of data is repeatedly used to perform learning. Therefore, a false correlation between state variables contained in the training data is strongly reflected in the prediction model 220 of a training result; that is, overfitting occurs and prediction performance is expected to be degraded. Meanwhile, by reducing the degree of freedom in the structure of the prediction model 220 using the knowledge about the function or the structure of the control target system 110, the number of parameters of the neural network to be trained is reduced, and constraints are given to the computational structure. As a result, the performance of each of interpolation and extrapolation is expected to be improved.

For example, each value of the output of f in the equation (1) expressing a temporal change of the state of each unit of the control target system 110 will be described. Regarding the i-th state variable x\hat{ }ᵢ and the j-th state variable x\hat{ }ⱼ of x\hat{ }, it is assumed that an apparatus i having a state x\hat{ }ᵢ and an apparatus j having a state x\hat{ }ⱼ are connected to each other by piping, and only the apparatus i is present for the input of the apparatus j. In this case, it is understood that at least x\hat{ }ᵢ and x\hat{ }ⱼ need be set for the input of a part for calculating dx\hat{ }ⱼ/dt.

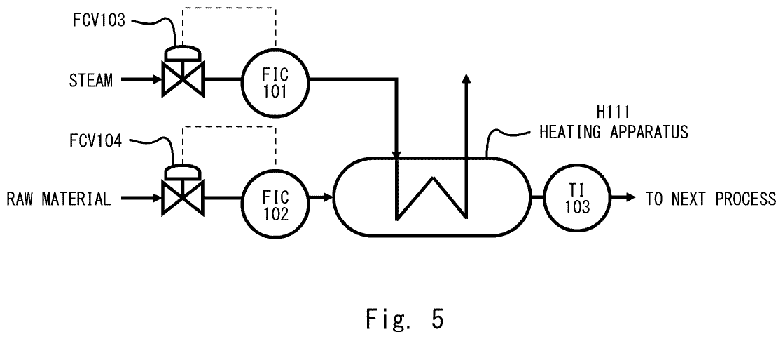

Examples of knowledge describing a connection relation between a partial element, such as an apparatus, and a partial element, such as piping, which partial elements constitute the control target system 110, include a Piping & Instrumentation Diagram (P&ID). For example, the control target system 110 composed of the plant indicated by the P&ID shown in FIG. 5 is a system having a function of supplying liquid or gaseous raw materials and steam to a heating apparatus H101, thereby heating the raw materials. In the plant shown in FIG. 5, a flow rate of the steam is controlled by a PID control apparatus FIC101. The PID control apparatus FIC111 adjusts the degree of opening of a control valve FCV103 so as to achieve a target flow rate (an SV value) input or specified as operation information. A flow rate of the raw materials is controlled by a PID control apparatus FIC102 in a manner similar to that by which a flow rate of the steam is controlled. The PID control apparatus FIC102 adjusts the degree of opening of a control valve FCV104 so as to achieve a specified target flow rate. A flowmeter, which measures the flow rate, is incorporated into each of the FICs. The raw material temperature after heating is measured by a thermometer TI103.

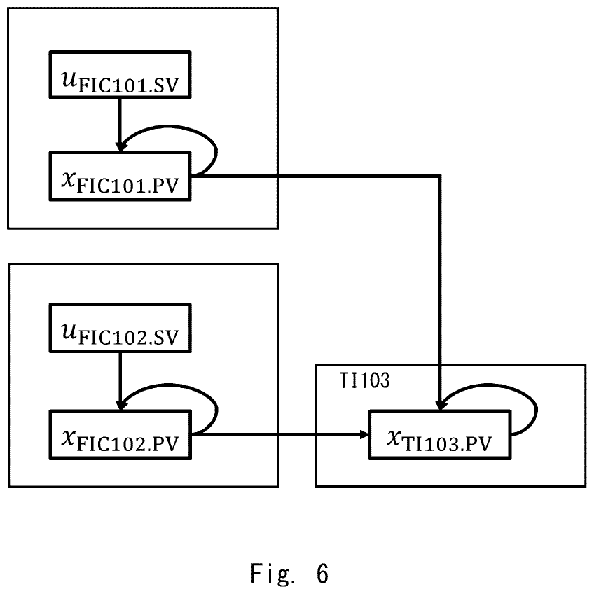

If the state of the plant shown in FIG. 5 is regarded as the measured value (the PV value) and the SV value of each of the flow rate and the temperature, the relation between the PV values can be converted into the directed graph shown in FIG. 6 by using the connection relation between the apparatuses by piping. This directed graph is a qualitative model of the plant showing the flow of materials and energy between the apparatuses, and can be regarded as a simplified model of the functional model such as MFM.

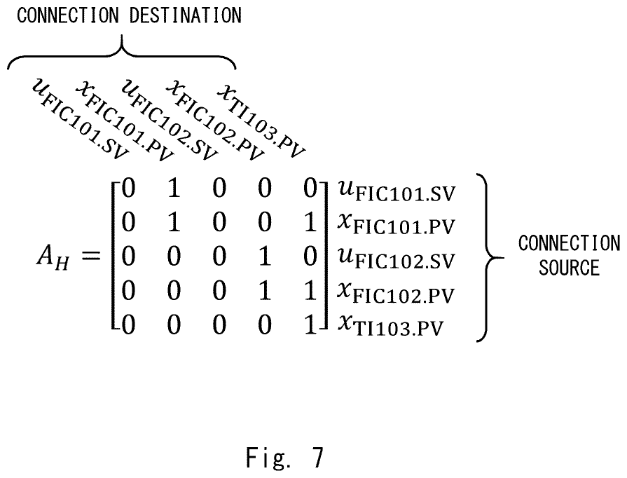

This directed graph is further converted into the adjacency matrix shown in FIG. 7. In an adjacency matrix A_{H} shown in FIG. 7, the index of each row and column indicates each state variable. In a case where there is a connection from the state variable indicated by the index of each row to the state variable indicated by the index of each column, the element value in this part of the adjacency matrix A_{H} is set to 1, and in a case where there is no connection, the element value is set to 0. As a result, the directed graph shown in FIG. 6 is converted into a matrix form.

If the structure of the plant constituting the control target system 110 is expressed as the adjacency matrix A_{H} shown in FIG. 7, the structure of a neural network f indicating the prediction model 220 is designed in accordance with the adjacency matrix A_{H} shown in FIG. 7. For example, by paying attention to the fifth column of the adjacency matrix A_{H} indicating dx\hat{ }_{TI103.PV}/dt as a substructure of f indicating the state change of a state variable x\hat{ }_{TI103.PV} shown in FIG. 7, a neural network in which a state variable having a value of 1 in each row is an input can be configured as shown in the equation (2).

$$[ Expression 2 ]$$

$$\frac{d {\hat{x}}_{TI 103. PV}}{dt} = {f}_{TI 103} ( {\hat{x}}_{FIC 101. {PV}_{‵}} {\hat{x}}_{FIC 102. {PV}_{‵}} {\hat{x}}_{TI 103. PV} ; {θ}_{TI 103} ) \qquad ( 2 )$$

In the equation (2),
θ TI103
is included in
[symbol] indicating a parameter of the entire f, and indicates a parameter of the neural network constituting f_{TI103}, which is a substructure of f.

In addition to TI103.PV, regarding the plant indicated by the P&ID shown in FIG. 5, f can be configured as shown in the equation (3)

$$[ Expression 3 ]$$

$$\frac{d \hat{x}}{dt} = [ \begin{matrix}{f}_{FIC 101} ( {\hat{x}}_{FIC 101. {PV}_{‵}} {u}_{FIC 101. SV} ; {θ}_{FIC 101} ) \\ {f}_{FIC 102} ( {\hat{x}}_{FIC 102. {PV}_{‵}} {u}_{FIC 102. SV} ; {θ}_{FIC 102} ) \\ {f}_{TI 103} ( {\hat{x}}_{FIC 101. {PV}_{‵}} {\hat{x}}_{FIC 102. {PV}_{‵}} {\hat{x}}_{TI 103. PV} ; {θ}_{TI 103} )\end{matrix} ] \qquad ( 3 )$$

Regarding a plant more complex than that in the P&ID shown in FIG. 5, a structural knowledge of the plant can be incorporated into a neural network by a method similar to the above method. Specifically, a structural knowledge of the plant can be incorporated into a neural network by converting the P&ID into a directed graph, further converting it into an adjacency matrix, and configuring a neural network that separately indicates the time derivatives of the state variables from the adjacency matrix and synthesizing it.

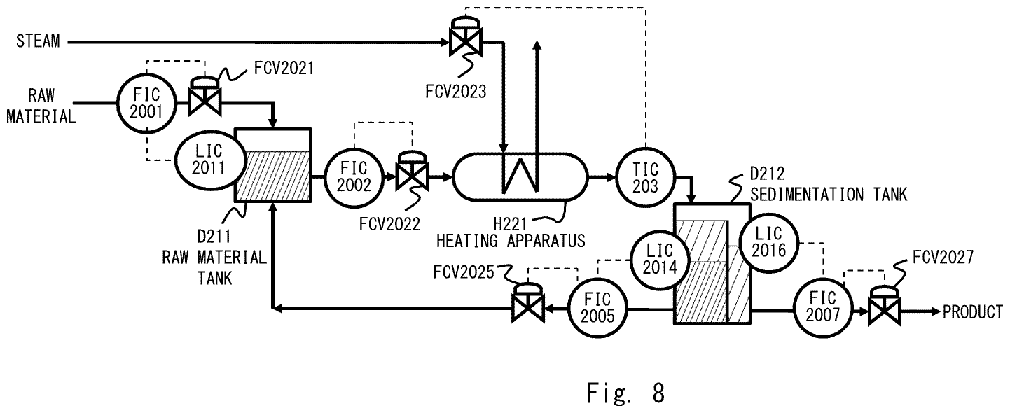

For example, in the plant indicated by the P & ID shown in FIG. 8, raw materials are stored in a raw material tank D211 and heated by a heating apparatus H221, and products having a specific gravity lower than that of the raw materials generated by the heating are transferred to a sedimentation tank D212. Further, the plant indicated by the P&ID shown in FIG. 8 separates the remaining raw materials that have not become products from the products, and extracts to the outside of the plant only the light products that have flowed over the wall installed inside the sedimentation tank D212.

The plant shown in FIG. 8 has a more complex structure than that of the plant shown in FIG. 5 since the plant shown in FIG. 8 has three processes of storage, heating, and separation. As for a PID control apparatus, a liquid level control apparatus LIC and a temperature control apparatus TIC are installed in addition to the FIC. In addition, an FIC2005 is cascade-connected to an LIC2014, and control apparatuses that adjust the FIC2005 so as to maintain a liquid level height of the boundary surface between two substances are included. Similarly, an LCI2011 is cascade-connected to an FIC2001.

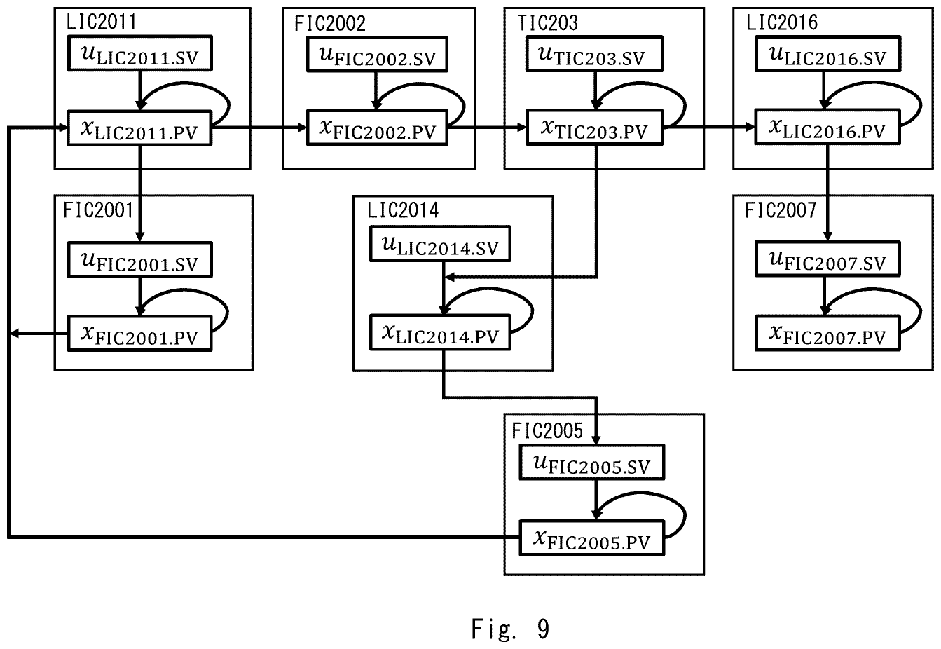

As shown in FIG. 9, the P&ID of the plant shown in FIG. 8 is converted into a directed graph showing a relation between state variables. The directed graph is further converted into an adjacency matrix, and a neural network indicating the time derivative of each of the state variables is configured, and the neural network f indicating the prediction model 220 is constructed by combining them.

As shown in the equation (3), not only the variables connected immediately before a certain state variable, but also the state variables present after further traced back to the input side may be used as inputs of the neural network that separately indicates the time derivatives of the state variables. For example, in a neural network f_{LIC201} for calculating a neural ordinary differential equation dx\hat{ }_{LIC201.PV}/dt expressing the plant behavior shown in FIG. 9, the input may not be limited to u_{LIC201.SV}, X\hat{ }_{LIC201.PV}, X\hat{ }_{FIC201.PV}, and x\hat{ }_{FIC205.PV}. For example, by tracing back one step, u_{FIC201.SV} and u_{FIC205.PV} may be used in addition to the neural network f_{LIC201}. Further, it is possible not only to trace back one step but also to trace back several steps.

The prediction model structure construction unit 210 constructs a neural ordinary differential equation expressing the prediction model 220. Specifically, the prediction model structure construction unit creates a neural network by determining a computational structure of the neural network constituting the neural ordinary differential equation based on knowledge data about the function or the structure of the control target system 110.

The partial derivative of the neural ordinary differential equation f using an input value u of a temporal change of the state is expressed as ∂f(x\hat{ }, u)/∂u.

Since this partial derivative can be calculated, a gradient method can be used in the optimization calculation for obtaining control inputs (or control information) that satisfy some objective by using the prediction model 220. As a result, it is expected that the optimization calculation can be completed in a relatively short time to obtain an optimal control input. The calculation of a predicted value of the state in the prediction model 220 is expressed as the equation (4).

$$[ Expression 4 ]$$

$$\hat{x} ( t + 1 ) = {\int }_{t}^{t + 1} f ( {x ( k )}_{‵} u ( k ) ; Θ ) dk \qquad ( 4 )$$

A method for calculating a predicted value of the state in a case where one step of time has elapsed from the state at a time t to the state at a time t+1 is shown here. The integral calculation of the equation (4) may be performed by using a numerical integration technique such as the fourth-order Runge-Kutta method.

The learning apparatus 300 performs learning of the prediction model 220. Specifically, the learning apparatus 300 adjusts a parameter
[symbol] of the prediction model 220 by using time-series data of input and output values of the control target system 110 incorporated into the control target apparatus 100 as training data. The learning apparatus 300 may be configured by using a computer.

The learning data input determination unit 310 determines an input value input to the control target apparatus 100 in order to collect training data from the control target apparatus 100. Further, the learning data input determination unit 310 outputs the determined input value to the control target system 110, and the model learning unit 320 collects time-series data of the output value of the control target system 110. The learning data input determination unit 310 may obtain operation information of the control target system 110, for example, by providing various types of target states to the control apparatus that brings the control target system 110 into a target state. However, a method for obtaining operation information of the control target system 110 is not limited thereto.

After collecting training data, the integral calculation unit 230 calculates a time series of the state, which is the output of the prediction model, from the time series of the input value in the prediction model 220 and the training data. The time series of the output value, which is a result of the calculation, is output from the prediction model apparatus 200. The prediction model apparatus 200 may be configured by using a computer.

The model learning unit 320 calculates a prediction error from the time series of the output value predicted and calculated by the prediction model apparatus 200 from the input value in training data and the time series of the output value in training data. A prediction error is a difference between the time series of the output value predicted and calculated by the prediction model apparatus 200 and the time series of the output value in training data.

The learning apparatus updates parameter values of the prediction model so as to reduce a prediction error. In order to do so, a steepest descent method based on partial derivatives (gradients) of parameter values in a prediction error may be used. However, a method for updating the parameter values is not limited thereto.

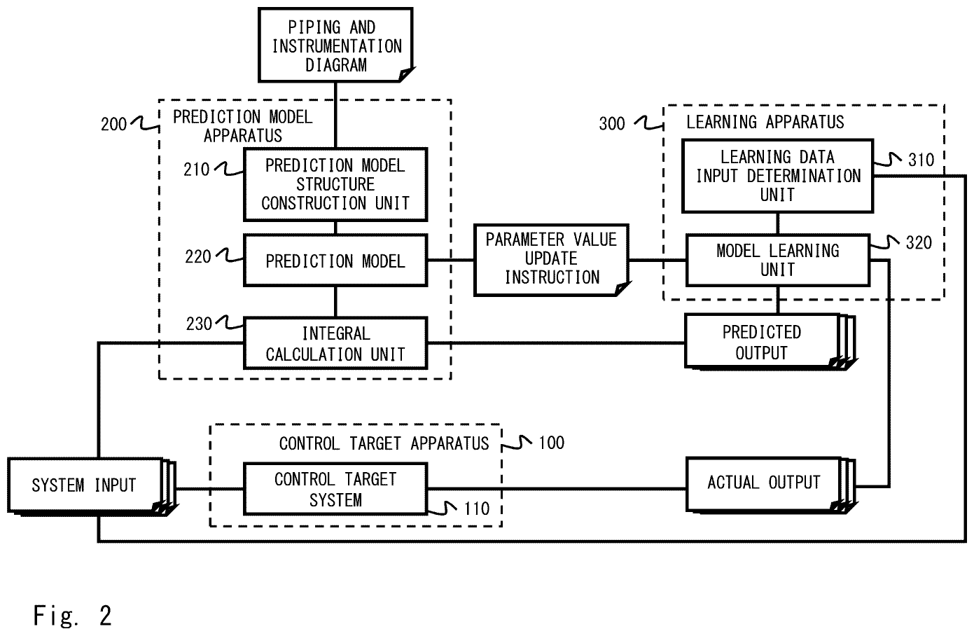

FIG. 2 is a diagram showing an example of input and output of data in the learning system 1. For example, data about the function or the structure of the control target system 110 described as a Piping and Instrumentation Diagram (P&ID) is input to the prediction model structure construction unit 210 of the prediction model apparatus 200. The prediction model structure construction unit 210 creates the prediction model 220 that uses a neural network reflecting the function or the structure of the control target system 110. Note that data about the function or the structure of the control target system 110 is not limited to the P&ID.

The model learning unit 320 outputs data indicating a learning state of the model to the learning data input determination unit 310.

The learning data input determination unit 310 determines a control input which is an input value of the control target system 110, and inputs it to the control target system 110. In parallel with the above process, the learning data input determination unit 310 may input the input value to the integral calculation unit 230 or may input it individually.

The control target system 110 outputs time-series data in accordance with the control input as a predicted output.

The integral calculation unit 230 outputs time-series data in accordance with the control input as an actual output.

The model learning unit calculates a prediction error from the actual output and the predicted output, and outputs a parameter value update instruction for minimizing the prediction error to the prediction model.

The prediction model 220 updates the parameter values of the prediction model 220 in accordance with the parameter value update instruction.

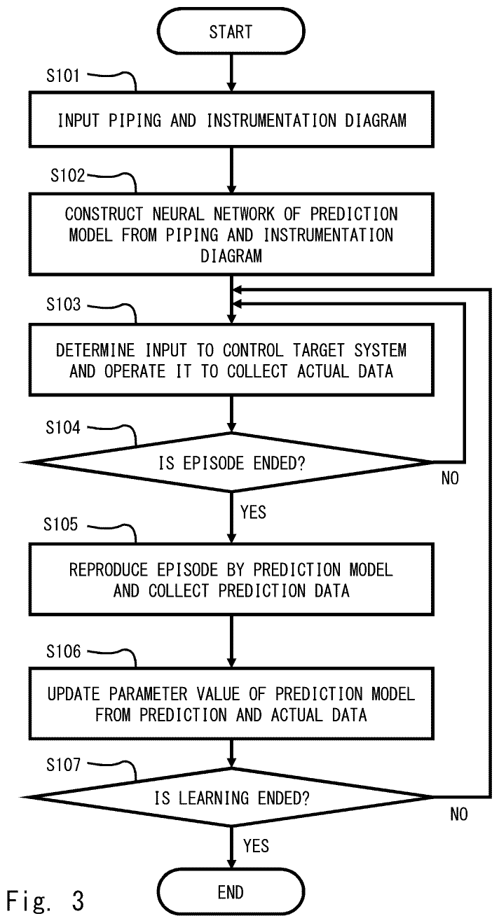

FIG. 3 is a diagram showing an example of a processing procedure in which the learning system 1 performs learning of the prediction model 220. In the processing shown in FIG. 3, data in which the function or the structure of the control target system 110 is described, such as a piping and instrumentation diagram, is input to the prediction model apparatus 200 (Step S101).

Next, the prediction model structure construction unit 210 of the prediction model apparatus 200 converts the data in which the function or the structure of the system is described into a directed graph showing the structure of the system. Further, the prediction model structure construction unit 210 constructs the prediction model 220 as a neural network reflecting the structure of the directed graph (Step S102).

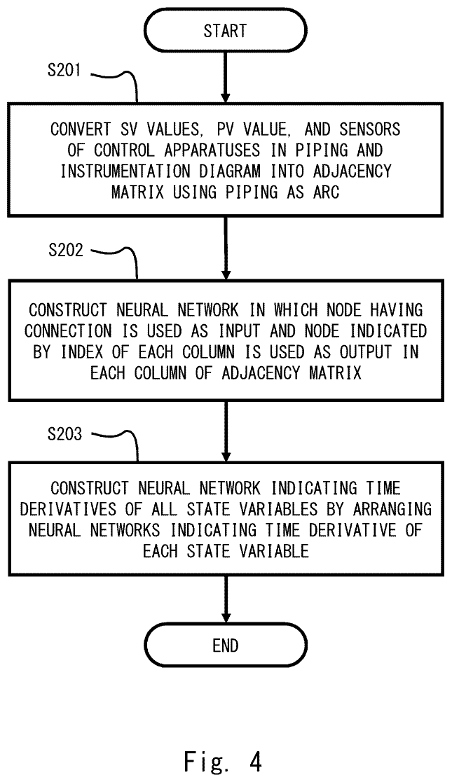

FIG. 4 is a diagram showing an example of a processing procedure in which Step S102 is further concretized. After a piping and instrumentation diagram is input to the learning apparatus 300, the prediction model structure construction unit 210 converts the SV values, the PV values, and the sensors of the control apparatuses described in the piping and instrumentation diagram into an adjacency matrix using the piping described in the piping and instrumentation diagram as an arc (Step S201).

Next, for each node indicated by each column of the adjacency matrix, the prediction model structure construction unit 210 specifies a node having an input relationship from the value of each row of the column. Further, the prediction model structure construction unit 210 constructs a neural network using the state variable indicated by the node as an input and the state variable corresponding to the node indicated as the column as an output (Step S202).

The prediction model structure construction unit 210 arranges the outputs of the constructed neural network, and constitutes a neural ordinary differential equation for outputting the time derivative of the PV value and the sensor value of each of the control apparatuses installed in the control target system 110 (Step S203).

Referring back to the processing shown in FIG. 3, the learning apparatus 300 determines an input value (a system input) input to the control target system 110 by the learning data input determination unit 310. The learning data input determination unit 310 collects time-series data of the input value and inputs the input value to the control target system 110 and operates it. The time-series data of the actual output is collected by the model learning unit 320 (Step S103).

A series of operations separated by time is referred to as an episode. For example, in an operation for increasing the rated amount of production of 80% to the rated amount of production of 100% in a chemical plant, a series of operations performed until the amount of production of 100% is reached from the amount of production of 80% is referred to as an episode. Note that the term “episode” is not limited to being referred to as an operation in a chemical plant, and is referred to, for example, as an operation of one stage of a video game. However, it is not limited thereto.

The learning data input determination unit 310 operates the control target system 110 for a certain period of time and determines whether or not an end condition of the episode is satisfied (Step S104). For example, a condition that a series of operation periods exceed a period specified in advance can be set as the end condition. However, it is not limited to being determined by the above method.

Next, the integral calculation unit 230 calculates, by using the system inputs collected by the learning data input determination unit 310 and the prediction model 220, predicted outputs by the prediction model and outputs them. The predicted outputs are collected by the model learning unit 320 (Step S105).

The model learning unit 320 calculates a prediction error from the collected actual outputs and predicted outputs, and outputs the updated parameter values to the prediction model 220 as a parameter value update instruction in order to minimize the error (Step S107).

### Second Example Embodiment

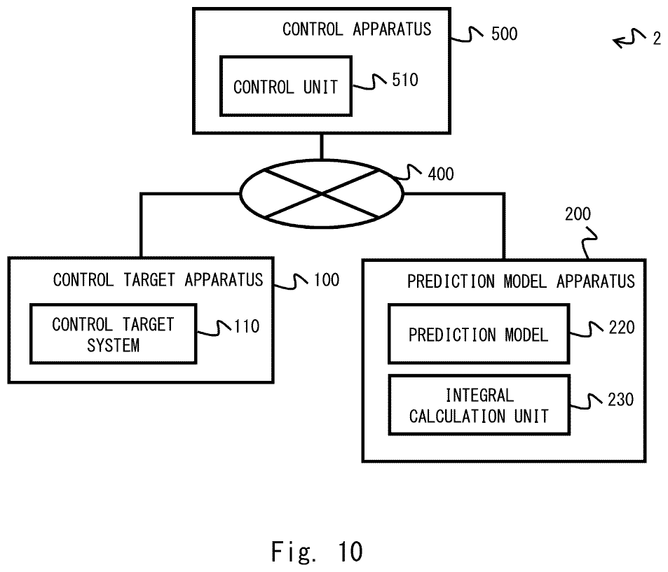

In a second example embodiment, a method for controlling the control target system 110 by using the trained prediction model 220 will be described. FIG. 10 is a diagram showing an example of a configuration of a control system according to at least one of the example embodiments. In the configuration shown in FIG. 10, the control system 2 includes the control target apparatus 100, the prediction model apparatus 200, and a control apparatus 500.

The control target apparatus 100 is an apparatus to be controlled by the control system 2, and is not limited to a specific system. The control apparatus 500 controls the control target apparatus 100. The control apparatus 500 may be configured using a computer. A control unit 510 performs control using the prediction model 220. Examples of a control method using the prediction model 220 include model predictive control. The model predictive control is a method for obtaining, by optimization calculation, an operation input that minimizes a difference between a target state and a predicted state starting from a current state of the control target system 110 by using a target state to be achieved in the control target system 110 or a time series of the target state as an input. The control method is not limited to the model predictive control, and it is also possible, for example, to learn a policy function for calculating an optimal control input from the state variable by reinforcement learning in advance and use the learned policy function as the control unit.

### Third Example Embodiment

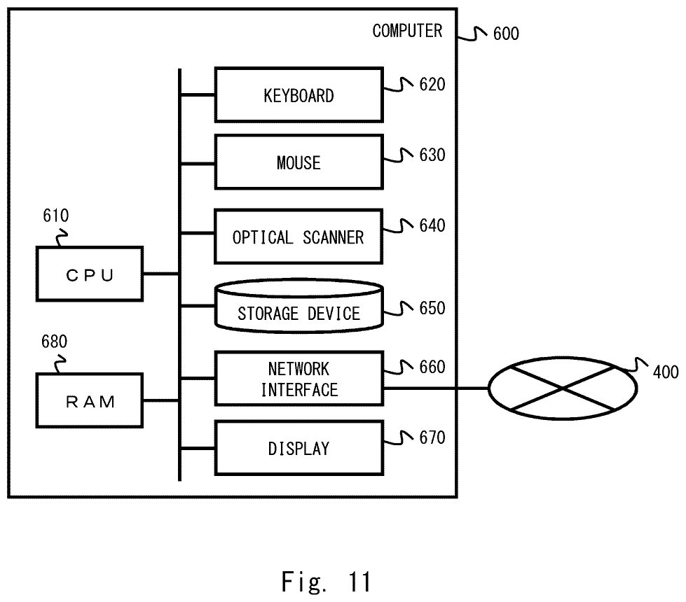

FIG. 11 is a diagram showing an example of a configuration of a computer according to at least one of the example embodiments.

In the configuration shown in FIG. 11, a computer 600 includes a CPU 610, a keyboard 620, a mouse 630, an optical scanner 640, a storage device 650, a network interface 660, and a display 670.

One or more of the control target apparatus 100, the prediction model apparatus 200, the learning apparatus 300, and the control apparatus 500 or a part thereof may be implemented in the computer 600. In a case where one of the apparatuses is implemented in the computer 600, the processing procedure of the implemented apparatus is stored in the storage device 650 in the form of a program. The CPU 610 reads the program from the storage device 650, deploys it in a random access memory RAM 680, and executes processing in accordance with the deployed program. The apparatuses implemented in the computer 600 communicate with each other through the network interface 660 and exchange data necessary for processing through the communication network 400. As means for inputting data to the computer 600, the keyboard 620, the mouse 630, and the optical scanner 640 can be used. For example, the optical scanner 640 can be used to input a piping and instrumentation diagram to the prediction model apparatus 200 implemented in the computer 600, and the keyboard 620 and the mouse 630 can be used to input a target state or the like in the control apparatus 500 implemented in the computer 600. The control apparatus 500 can present the calculated optimal operation input value to a user by using the display 670.

In the above-described examples, the program includes instructions (or software codes) that, in a case where it is loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storages, a magnetic cassette, a magnetic tape, and a magnetic disc storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A learning apparatus comprising:
means for determining a structure of a prediction model from information about a function and a structure of a control target system;
learning data input value determination means for determining an input value to be used to perform learning of the prediction model; and
model learning means for updating a parameter of the prediction model so that a difference between an output value of the control target system and an output value of the prediction model that are output in response to an input of the input value becomes small.

### (Supplementary Note 2)

The learning apparatus according to supplementary note 1, wherein the means for determining a structure of the prediction model determines the structure of the prediction model by using knowledge data about the function and the structure of the control target system.

### (Supplementary Note 3)

The learning apparatus according to supplementary note 2, wherein the means for determining a structure of the prediction model determines the structure of the prediction model by using data about a connection relation between apparatuses constituting the control target system.

### (Supplementary Note 4)

The learning apparatus according to supplementary note 3, wherein the means for determining a structure of the prediction model determines the structure of the prediction model by using a piping and instrumentation diagram of the control target system as an input.

### (Supplementary Note 5)

The learning apparatus according to supplementary note 4, wherein the means for determining a structure of the prediction model determines the structure of the prediction model by using a directed graph showing a relation between state variables, the directed graph being obtained by converting the piping and instrumentation diagram.

### (Supplementary Note 6)

The learning apparatus according to supplementary note 5, wherein the means for determining a structure of the prediction model determines the structure of the prediction model by using an adjacency matrix converted from the directed graph.

### (Supplementary Note 7)

The learning apparatus according to supplementary note 1, wherein the prediction model is expressed as a neural ordinary differential equation.

### (Supplementary Note 8)

A control apparatus comprising control means for controlling a control target apparatus by using a prediction model determined based on information about a function and a structure of a control target system.

### (Supplementary Note 9)

A learning method performed by a computer, the learning method comprising:
determining a structure of a prediction model from information about a function and a structure of a control target system;
determining an input value to be used to perform learning of the prediction model; and
updating a parameter of the prediction model so that a difference between an output value of the control target system and an output value of the prediction model that are output in response to an input of the input value becomes small.

### (Supplementary Note 10)

A non-transitory computer readable medium storing a program for causing a computer to:
determine a structure of a prediction model from information about a function and a structure of a control target system;
determine an input value to be used to perform learning of the prediction model; and
update a parameter of the prediction model so that a difference between an output value of the control target system and an output value of the prediction model that are output in response to an input of the input value becomes small.

Some or all of elements (e.g., structures and functions) specified in Supplementary Notes 2 to 7 dependent on Supplementary Note 1 may also be dependent on Supplementary Notes 8 to 10 in dependency similar to that of Supplementary Notes 2 to 7 on Supplementary Note 1. Some or all of elements specified in any of Supplementary Notes may be applied to various types of hardware, software, and recording means for recording software, systems, and methods.

What is claimed is:

1. A learning apparatus comprising:
at least one memory storing instructions, and
at least one processor configured to execute the instructions to;
determine a structure of a prediction model from information about a function and a structure of a control target system;
determine an input value to be used to perform learning of the prediction model; and
update a parameter of the prediction model so that a difference between an output value of the control target system and an output value of the prediction model that are output in response to an input of the input value becomes small.

2. The learning apparatus according to claim 1, wherein the at least one processor is further configured to execute the instructions to determine the structure of the prediction model by using knowledge data about the function and the structure of the control target system.

3. The learning apparatus according to claim 2, wherein the at least one processor is further configured to execute the instructions to determine the structure of the prediction model by using data about a connection relation between apparatuses constituting the control target system.

4. The learning apparatus according to claim 3, wherein the at least one processor is further configured to execute the instructions to determine the structure of the prediction model by using a piping and instrumentation diagram of the control target system as an input.

5. The learning apparatus according to claim 4, wherein the at least one processor is further configured to execute the instructions to determine the structure of the prediction model by using a directed graph showing a relation between state variables, the directed graph being obtained by converting the piping and instrumentation diagram.

6. The learning apparatus according to claim 5, wherein the at least one processor is further configured to execute the instructions to determine the structure of the prediction model by using an adjacency matrix converted from the directed graph.

7. The learning apparatus according to claim 1, wherein the prediction model is expressed as a neural ordinary differential equation.

8. A learning method performed by a computer, the learning method comprising:
determining a structure of a prediction model from information about a function and a structure of a control target system;
determining an input value to be used to perform learning of the prediction model; and
updating a parameter of the prediction model so that a difference between an output value of the control target system and an output value of the prediction model that are output in response to an input of the input value becomes small.

9. A non-transitory computer readable medium storing a program for causing a computer to:
determine a structure of a prediction model from information about a function and a structure of a control target system;
determine an input value to be used to perform learning of the prediction model; and
update a parameter of the prediction model so that a difference between an output value of the control target system and an output value of the prediction model that are output in response to an input of the input value becomes small.
